(19) United States
(12) Patent Application Publication
(10) Pub. No.: US 2006/0242279 A1
(43) Pub. Date: Oct. 26, 2006

(54) Methods of wireless data synchronization and supporting apparatus and readable medium

(76) Inventors: Bonnie Chen, DeSoto, TX (US); Johanna A. Wild, Munich (DE)

Correspondence Address: MOTOROLA, INC., 1303 EAST ALGONQUIN ROAD, IL01/3RD, SCHAUMBURG, IL, 60196, US

(21) Appl. No.: 11/113,584

(22) Filed: Apr. 25, 2005

(51) Int. Cl. G06F 15/177

(52) U.S. Cl. 709/221

(57) ABSTRACT

In the present technique of wireless data synchronization, a data synchronization request to wirelessly synchronize data related to the request with a server is intercepted (304). Synchronization information of the data synchronization request to the server is assessed (306) to determine (308) whether the synchronization information corresponds in at least a predetermined way to a predefined condition. The data related to the data synchronization request is synchronized (310) with the server when the synchronization information corresponds in at least the predetermined way to the predefined condition.

### TECHNICAL FIELD

This invention relates generally to wireless data synchronization between a mobile station and a server.

### BACKGROUND

In recent years, numerous new features that have been traditionally available only at home are now becoming standards in cellular telecommunication networks. One of the most notable features is the availability of the Internet Protocol (“IP”) based services (e.g., push to talk services) through the use of cell phones. Today, with all these available features on cell phones, there is practically no difference between computer functionality and cell phones. To avoid confusion, the single term “mobile station” will be used to describe the various devices that can work with other multiple networks, such as the Internet. Specifically, mobile station will be used to refer to any mobile device, which may include, but is not limited to, a desktop computer, a laptop computer, a personal digital assistant, and/or a cell phone, that uses a specific network, such as a cellular network, for access to other networks.

Within the mobile networks, configuration data (e.g., service attributes, group lists, presence information, service related policies, and so forth) of these multiple IPs based services are typically stored in either the mobile station and/or the network via a server. Although data that are temporarily stored in the mobile station can be used to achieve the same user experience as in the case where the data are stored in the network, the data stored in the network may provide a more optimized usage of air interface resources. For example, when a service attribute of “incoming session barring” for a push to talk over cellular (“PoC”) is stored at the network, the usage of air interface resources tends to be more efficient, since the network, in this case, precludes the sending of a Session Initiation Protocol (“SIP”) invite to the mobile station. As a result, instantaneous synchronization of these types of information between the mobile station and the server may be desired, depending upon the type of the IP based services.

There are currently several prior methods available for data synchronization in wireless networks. These other prior methods, however, all use significant resources of the over the air interface and within the network. As an example, one method proposes to use the SIP registration method to set the PoC service attributes, such as a manual answer and incoming session barring in the PoC server. Another proposal is to use Extensible Markup Language Configuration Access Protocol (“XCAP”) to update service related configuration data. These proposed methods, however, consume a great deal of resources of the over the air interface and are generally very process-intensive on the mobile station and the network.

### BRIEF DESCRIPTION OF THE DRAWINGS

The above needs are at least partially met through provision of the wireless data synchronization described in the following detailed description, particularly when studied in conjunction with the drawings, wherein:

FIG. 1 comprises a block diagram of an exemplary wireless communications system suitable for various embodiments of the invention;

FIG. 2 comprises a block diagram of a mobile station according to various embodiments of the invention;

FIG. 3 comprises a flow chart diagram of a synchronization process according to various embodiments of the invention;

FIG. 4 comprises a flow chart diagram of a synchronization process according to an embodiment of the invention;

FIG. 5 comprises a flow chart diagram of an assessment process according to an embodiment of the invention shown from FIG. 4;

FIG. 6 comprises a flow chart diagram of an assessment process according to an embodiment of the invention shown from FIG. 4; and

FIG. 7 comprises a flow chart diagram of an assessment process according to an embodiment of the invention shown from FIG. 4.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a wireless data synchronization technique has been provided. Specifically, a data synchronization request is intercepted that wirelessly synchronizes data related to the request with a server. Synchronization information related to the data synchronization request is assessed to determine whether the synchronization information corresponds in at least a predetermined way to a predefined condition. The data related to the data synchronization request is synchronized with the server when the synchronization information corresponds in at least the predetermined way to the predefined condition.

According to various embodiments, the synchronization information includes a variety of information, such as a type of data to be synchronized, a total number of bytes needed to effectuate synchronizing the data related to the data synchronization request with the server, a total number of messages needed to effectuate synchronizing the data related to the data synchronization request with the server, historical information, learned user behavior, synchronization delay saving, profile information, signal condition, and pending synchronization operation. The predefined condition, on the other hand, may include at least one threshold, historical data, profile information, time duration, maximum number of requests per time duration, prospective savings, signal condition, a total number of data synchronization requests intercepted for a predefined time, pending synchronization operation, and synchronization forced by the user. In various teachings of the embodiments provided, the data synchronization request can include a push to talk session barring flag, a push to talk burst barring flag, changed data in contact lists, changed data in access lists, presence data, and service policy data.

In one embodiment, synchronization of the data related to the data synchronization request with the server is at least delayed when the synchronization information does not correspond in at least the predetermined way to the predefined condition. According to an embodiment, prior to the assessment of the synchronization information of the data synchronization request to the server, a data type of the data related to the data synchronization request is assessed to provide an assessed data type, wherein the predefined condition is based on the assessed data type. In one embodiment, a total number of the data synchronization requests of a same data type is further examined to determine whether it corresponds in at least a predetermined way to a seldom threshold, and if so, the data related to the data synchronization request is synchronized with the server. According to an embodiment, a determination of whether immediate data synchronization is required is made based on the assessed data type. Furthermore, the synchronization with the server further includes a determination as to whether other related data are required for synchronization and to prepare such other related data along with the data related to the data synchronization request when other related data are required for synchronization.

According to an embodiment of the determination of whether the synchronization corresponds in at least a predetermined way to the at least one predefined condition, a total number of messages needed to synchronize the data related to the data synchronization request is assessed. Next, a total number of messages to be blocked from the data synchronization request based on historical data is estimated. A determination is made as to whether the total number of messages to be blocked corresponds in at least a predetermined way to the total number of messages needed, and if not, the synchronization is delayed. In another embodiment, a total number of bytes needed to synchronize the data related to the data synchronization request is assessed, and a total number of bytes to be blocked from the data synchronization request based on historical data is estimated, followed by a determination of whether the total number of bytes to be blocked corresponds in at least a predetermined way to the total number of bytes needed. If not, the data synchronization with the server is again delayed. According to one embodiment, the determination of whether the synchronization corresponds in at least a predetermined way to the predefined condition includes a determination of whether a delay timer corresponds in at least a predetermined way to a timer threshold, and if not, synchronization is delayed. Another embodiment provides an assessment of memory required to synchronize the data related to the data synchronization request, and comparing this assessment to determine whether it corresponds in at least a predetermined way to a memory threshold. If not, data synchronization is again delayed.

According to various embodiments, an apparatus is further provided with an interception circuit that intercepts a data synchronization request to wirelessly synchronize data related to the request with a server and an assessor circuit that assesses synchronization information related to the data synchronization and compares the synchronization information with a predefined condition such that the data synchronization is synchronized with the server based on the comparison. In one embodiment, the apparatus further includes a synchronization circuit that synchronizes data requested by the data synchronization request with the server responsive to instructions from the assessor circuit or a user request. According to an embodiment, the assessor circuit further determines whether the synchronization information corresponds in at least a predetermined way to the predefined condition and instructs synchronization of the data related to the data synchronization request with the server when the synchronization information corresponds in at least the predetermined way to the predefined condition and at least delays the synchronization with the server, otherwise.

According to various embodiments, a computer-readable medium having computer-executable instructions is also provided. In particular, the computer-readable medium performs the steps of intercepting a data synchronization request to wirelessly synchronize data related to the data synchronization request with a server, assessing synchronization information of the data synchronization request, determining whether the synchronization information corresponds in at least a predetermined way to a predefined condition, and synchronizing the data related to the data synchronization request with the server when the synchronization information corresponds in at least the predetermined way to the predefined condition.

Through the embodiments of various teachings, the balance between the benefits of data synchronization with the server and the cost of such synchronization is optimized. As one example, service configuration data may be temporarily stored in the mobile station to achieve the expected user experience, while data synchronization with the server is done on a more efficient basis. Since, through the various teachings described, numerous characteristics (e.g., lifetime of the data based on policies and user behavior, magnitude of data, frequency of change, impact of storage location on the air interface resource usage) are considered, an optimized synchronization technique between the mobile station and the server via a wireless network is provided, as a result. With the various embodiments, historical information on the user behavior are maintained and used to further provide optimization of the data synchronization frequency between the mobile station and the server. Moreover, because such historical information is tracked, a more intelligent process can be developed to determine an optimized synchronization timing based on the tracked historical information and real time changes to this information. A more dynamic, efficient, and robust wireless data synchronization is thus provided through the numerous embodiments described.

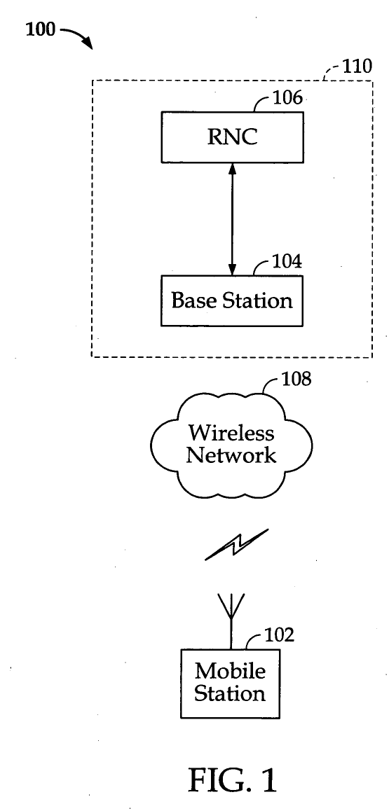

Referring now to the drawings, and in particular to FIG. 1, for purposes of providing an illustrative but non-exhaustive example to facilitate this description, a specific operational paradigm using a wireless communication network is shown and indicated generally at 100. Those skilled in the art, however, will recognize and appreciate that the specifics of this illustrative example are not specifics of the invention itself and that the teachings set forth herein are applicable in a variety of alternative settings. For example, since the various teachings are not platform dependent, they can be applied to any communication network that includes different types of data transmission. Thus, any digital broadcast services or digital satellite services may also applicable. These various platforms and network implementations are, as a result, within the scope of the invention, and various embodiments for these multiple implementations are readily understood and appreciated by one skilled in the art.

Pursuant to this example, a mobile station (“MS”) 102 communicates with a base station (“BS”) 104 that is operably coupled to a radio network controller (“RNC”) 106 via a wireless network 108. As commonly known in the art, the RNC 106 typically controls multiple BSs 104 (one shown) for data transmission between the mobile station 102 and the serving BS 104. In this example, typical of a general communication network, the mobile station 102 sends requests and/or data to the serving BS 104, which, in turn, forwards the requests and/or data to the RNC for processing. The BS 104 and the RNC 106, as shown, cooperatively route data to multiple mobile stations 102 (one shown), but depending upon the system, the network may include other components with different arrangement of these components. Thus, the communication system 100 shown is only one of many typical exemplary structures of a cellular communication network that is suitable for use with various described embodiments. Moreover, the RNC 106 along with the BS 104 will herein be referred to as a server 110 to emphasize that the data synchronization may include communications with either or both the RNC and the BS, depending upon the configuration of the system.

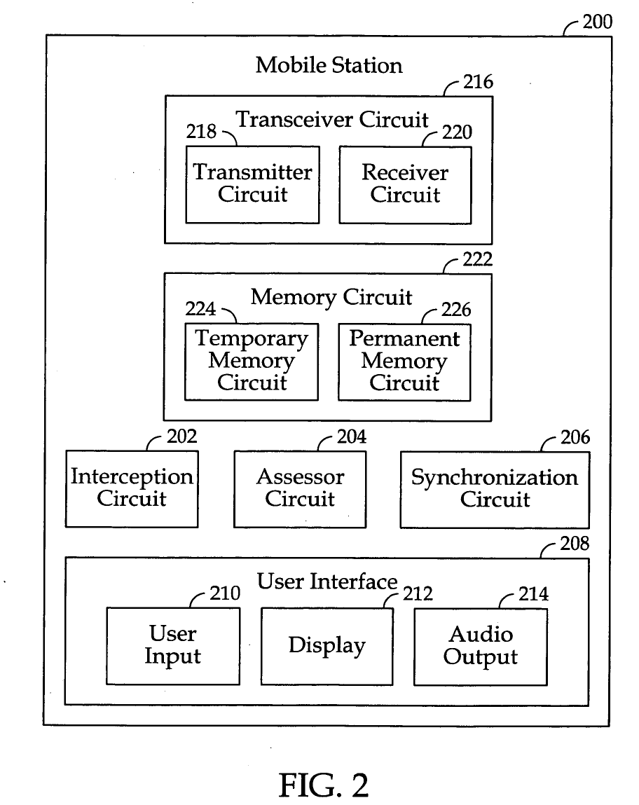

Turning now to FIG. 2, a block diagram of a mobile station according to various embodiments is shown and indicated generally at 200. Please note that as readily appreciated by one skilled in the art, the circuits and the arrangement of these circuits shown are only given as one of many configurations and circuitry topologies available, and these various alternative embodiments, although not shown, are readily appreciated by a skilled artisan. Thus, these alternative embodiments are within the scope of the various teachings described. It is further assumed that these circuits are coupled or connected to each other in the block diagram. Moreover, since the mobile station shown is a partial view of circuitry topology of a mobile device, the mobile station 200 shown does not necessarily include all of the components required of a typical mobile station. As such, it should be understood that the various teachings may include other circuit components that may not be shown but are well known to one skilled in the art. Moreover, “circuit” refers to hardware, firmware, and/or software, which may be used to implement any type of executable logic and/or instructions. Thus, these various embodiments of the circuit are contemplated and are all within the scope of the various teachings described.

A data synchronization request with the server 110 may be triggered from an action either by the user, the mobile station, and/or the server. The data synchronization request, for example, can include a number of items, such as a push to talk session barring flag, a push to talk burst barring flag, changed data in contact lists, changed data in access lists, presence data, and service policy data. Of course, other items of information may be represented and/or included with the data synchronization request, and these alternative embodiments are within the scope of the teachings described. Typically, this data synchronization request is serviced instantaneously by the mobile station substantially immediately sending data related to the data synchronization request to the server via the wireless network 108. In other words, data synchronization is substantially immediately effectuated via instant communication from the mobile station 200 to the server 110. In the present mobile station 200 shown, however, an interception circuit 202 is included to intercept such data synchronization requests before initiating any communication with the server 110 via the network.

Responsive to the data synchronization request, an assessor circuit 204 is used for assessing synchronization information related to the data synchronization request. The synchronization information may include a type of data to be synchronized, a total number of bytes needed to effectuate synchronizing the data related to the data synchronization request with the server, a total number of messages needed to effectuate synchronizing the data related to the data synchronization request with the server, historical information, learned user behavior, synchronization delay savings, profile information, signal condition, and pending synchronization operation. The assessor circuit 204 then compares this assessed synchronization information to a predefined condition, and the data synchronization request is synchronized with the server based on this comparison.

In particular, in one embodiment, the assessor determines whether the synchronization information corresponds in at least a predetermined way to the predefined condition, and if so, an instruction to service the data synchronization request is sent. Otherwise, according to one embodiment, the assessor circuit at least delays the synchronization of the data related to the data synchronization request with the server. Furthermore, in this specific embodiment shown, the instruction to synchronize with the server is specifically sent to a synchronization circuit 206 that ultimately synchronizes the data related to the data synchronization request with the server responsive to the instruction from the assessor circuit. In various embodiments, multiple predefined conditions can trigger the instruction to the synchronization circuit 206 for data synchronization with the server. For example, the predefined condition may include, but is not limited to, at least one threshold, historical data, profile information, time duration, maximum number of requests per time duration, prospective savings, signal condition, a total number of data synchronization requests intercepted for a predefined time, pending synchronization operation, and synchronization forced by the user. As one skilled in the art would readily appreciate, other predefined conditions, although not specifically identified, may also be used.

Aside from the assessor circuit 204, an instruction demanding data synchronization with the server can also be sent by a user. In this case, the user can forward such instruction to the synchronization circuit 206 through a user interface 208 that includes a user input 210, a display 212, and an audio output 214. Once the synchronization circuit 206 receives the instruction for data synchronization with the server, it accordingly synchronizes the data related to the data synchronization request with the server 110 via a transceiver circuit 216, which includes a transmitter circuit 218 and a receiver circuit 220. In various embodiments, a memory circuit 222, which includes a temporary memory circuit 224 and a permanent memory circuit 226, is further included to store or maintain the needed predefined condition and/or the synchronization information. Moreover, the memory circuit 222 can also be used as a computer-readable medium to store the computer-executable instructions implemented with the various embodiments of the invention.

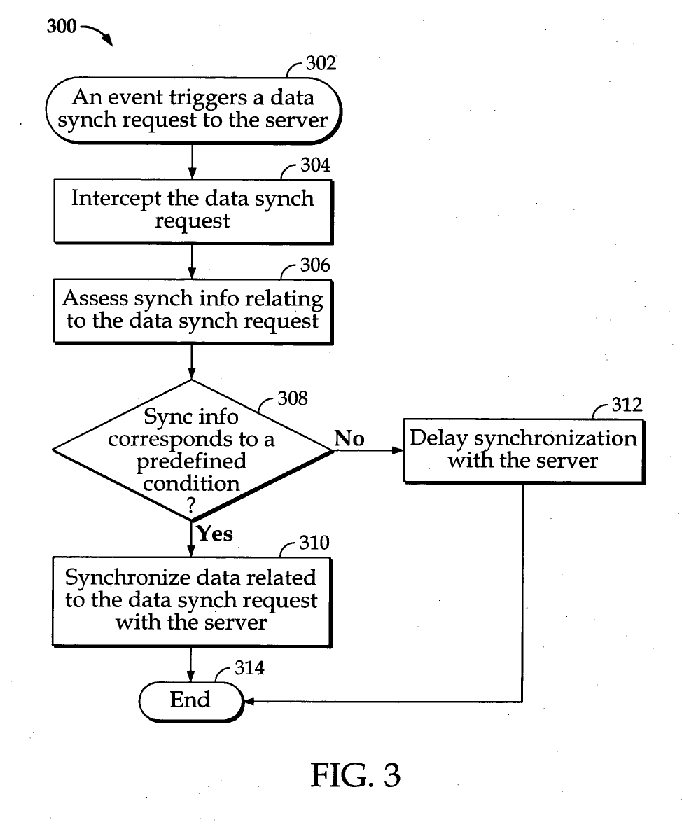

Turning now to FIG. 3, a flow chart diagram of a synchronization process according to various embodiments of the invention is shown and indicated generally at 100. Although the process shown is preferably implemented at the mobile station, there may be other implementations better suited for other components in the communication system. For example, these processes, as shown, can be implemented fully or partially at either the mobile station 102 or server 110. Thus, as a skilled artisan would readily appreciate, the flow diagram may be altered according to these different implementations. And as such, other embodiments of the synchronization process are contemplated and are within the scope of the various teachings shown. Moreover, as one skilled in the art would readily appreciate, any of the processes shown can be altered in multiple ways to achieve the same functions and results of the various teachings described. As a result, these processes shown are one exemplary embodiment of multiple embodiment variations that may not be specifically shown. These other embodiments, however, are within the scope of the various teachings described.

In this particular example shown, the process is initiated 302 with an event triggering a data synchronization request from the mobile station to the server. The triggering events can varied. For example, they can include a direct request to synchronize from the user, a push to talk barred of incoming calls, a change in the data of a contact list or an access list on the mobile station, presence data regarding the availability of the user using the mobile station, or service policy data. The data synchronization request is intercepted 304 before any communication is initiated on the network. Responsive to the data synchronization request, synchronization information relating to the data synchronization request is assessed 306. Specifically, depending upon the type of data synchronization request or the configuration of the system, various types of synchronization information, particularly information that may be relevant or useful for optimizing data synchronization between the mobile station and the server, can be collected at this point. Some of these examples can include a type of data to be synchronized, a total number of bytes needed to effectuate synchronizing the data related to the data synchronization request with the server, a total number of messages needed to effectuate synchronizing the data related to the data synchronization request with the server, historical information, learned user behavior, synchronization delay savings, profile information, signal condition, and pending synchronization operation.

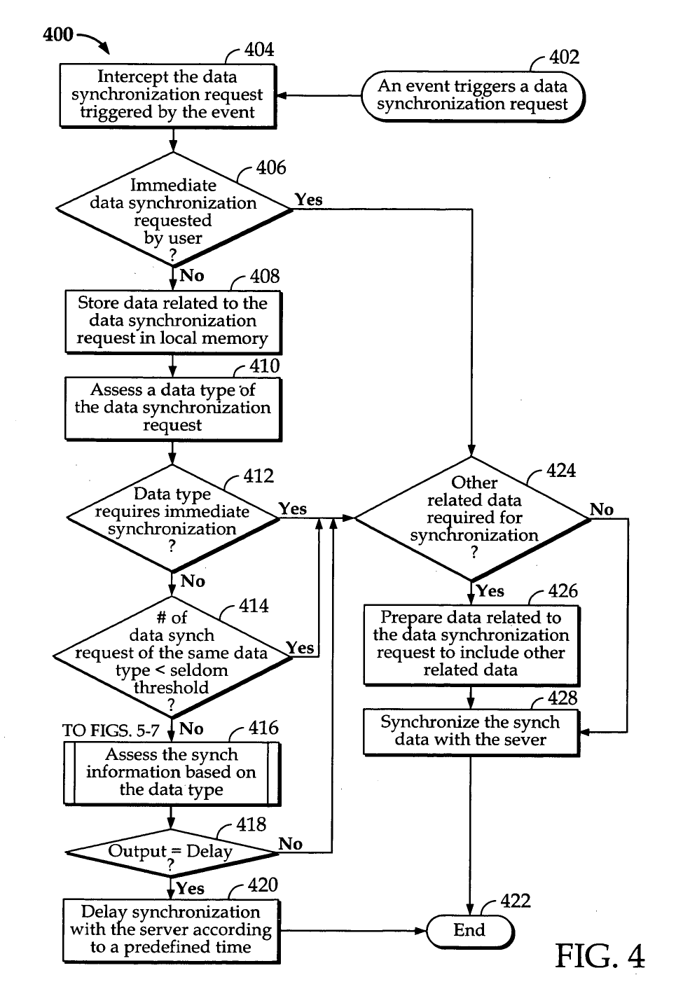

After the assessed synchronization information has been obtained 306, the assessed synchronization information is compared to determine 308 whether it corresponds to a predefined condition. If so, the data synchronization request is serviced. Specifically, the data related to the data synchronization request is synchronized 310 with the server. Otherwise, the data synchronization with the server is at least delayed 312. The process comes to an end 314 at this point. The predefined condition can also vary depending upon the type of synchronization information obtained. For example, the predefined condition can include at least one threshold, historical data, profile information, time duration, maximum number of requests per time duration, prospective savings, signal condition, a total number of data synchronization requests intercepted for a predefined time, pending synchronization operation, and synchronization forced by the user. More specific implementations of the types of predefined conditions will be described in the following FIGS. 4-7.

Turning now to FIG. 4, a flow chart diagram of a synchronization process according to an embodiment of the invention is shown and indicated generally at 400. This process starts 402 with an event triggering a data synchronization request with the server, which is intercepted 404 before any communication with the network or server is established. Responsive to this data synchronization request, a determination is made 406 as to whether an immediate data synchronization has been requested by a user of the mobile station. If not, data related to the data synchronization request is stored 408 in the local memory of the mobile station. A data type of the data synchronization request is then assessed 410 in order to determine 412 whether the data synchronization request is of a type that requires immediate synchronization based on the assessed data type. If not, the process continues to determine 414 whether a number of the data synchronization request of a same data type corresponds, specifically less than according to this embodiment shown, to a seldom threshold.

The seldom threshold is provided to set a predefined value to determine a minimum threshold of the frequency in which the data synchronization request of this type has been requested. For example, if the seldom threshold is set to one request per week, a value of being less than the seldom threshold indicates that the frequency of this type of data synchronization request is fairly rare. In this case, it may be more sufficient to accommodate requests that are not frequently requested. On the other hand, when a data synchronization request of a certain type has been requested ten times in the last five minutes, this may indicate that the user is browsing their contact list and that it would be inefficient to synchronize with the server until the user has finished browsing the contact list. The seldom threshold is implemented as a minimum allowance for instant synchronization based on the frequency of the data synchronization requests. Of course, the best optimized seldom threshold for a given configuration is readily appreciated by a skilled artisan, and thus a wide range of values can be used for the seldom threshold and these values are within the scope of the various teachings described.

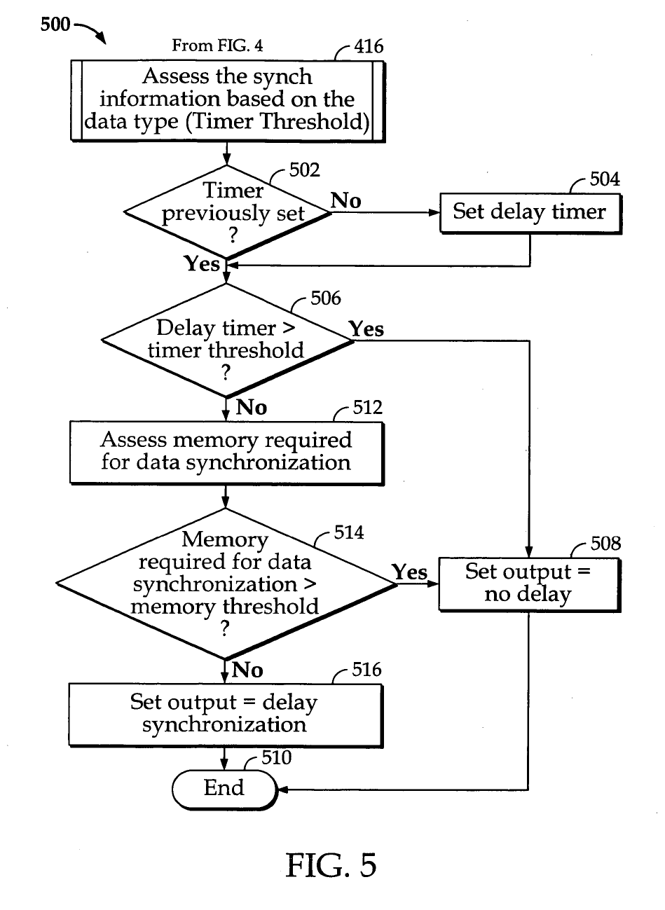

Continuing with the synchronization process 400, if the number of data synchronization requests does not correspond to (e.g., is not less than) to the seldom threshold, specific synchronization information related to the data synchronization request is assessed 416 based on the data type of the request via a subroutine shown in FIGS. 5-7. The assessment subroutine 416 will return with an output of delay or not to delay, which is determined 418 as criteria to synchronize or delay. In particular, if the output from the assessment subroutine process 416 is to delay, data synchronization with the server is accordingly delayed 420 according to a predefined time, which ends 422 the process at this point. Since the optimized value of this predefined time depends upon multiple parameters, such as the configuration of the system, the various teachings again contemplate a wide range of values of the predefined time, which is within the scope of the various teachings described.

If, on the other hand, it has been determined that the data synchronization request should be serviced either based on an immediate data synchronization request from the user 406 or based on the data type 412, correspondence to the seldom threshold 414, and/or the output from the assessment subroutine process of no delay 418, it is next determined 424 whether other related data are required for the synchronization with the server. Depending upon the type of data being synchronized, the process may need to acquire more related data to effectuate the synchronization. For example, when data synchronization is invoked by a change in presence data, such as the user of the mobile station is now being available, this may require additional related information (e.g., policy and/or usage information) in order to synchronize the availability of the user with the server. In cases where such other related data are needed, data related to the data synchronization request are prepared 426 to include these other related data. The data related to the data synchronization request, either with or without the other related data, is accordingly synchronized 428 with the server.

Turning now to FIG. 5, a flow chart diagram of an assessment process according to an embodiment of the invention from FIG. 4 is shown and indicated generally at 500. The assessment process 500 in this embodiment shown is based on a timer threshold, which starts with a determination as to whether a timer has been previously set 502. If not, a delay timer is accordingly set 504 to provide a delay timer value. Once a delay timer has been obtained, it is next determined 506 whether the delay timer corresponds at least in a predetermined way (e.g., greater than in this embodiment shown) to a timer threshold, and if so, the output is set 508 to no delay (e.g., synchronize now with the server), which brings 510 the subroutine 500 to an end. Otherwise, the memory required for the data synchronization is assessed 512 and used to determine 514 whether it corresponds to a memory threshold, and if so, the output is again set 508 to no delay. Otherwise, when the memory required for data synchronization does not correspond to the memory threshold, the output is set 516 to delay the synchronization with the server. The process ends 510 at this point.

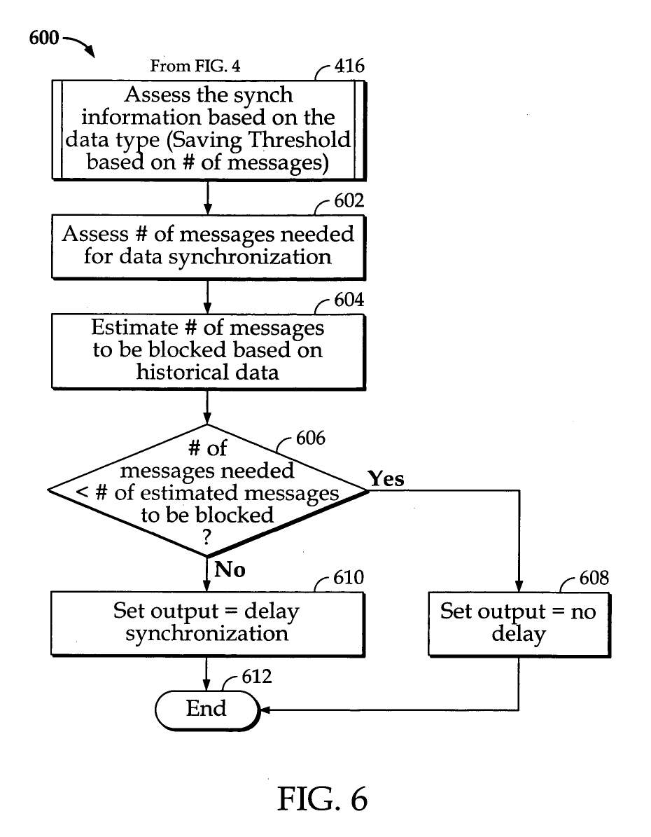

Referring to FIG. 6, a flow chart diagram of an assessment process according to one embodiment of the invention from FIG. 4 is shown and indicated generally at 500. In this embodiment, a saving threshold that is based on a total number of messages is used. In particular, the assessment process 500 begins with an assessment of a total number of messages needed to effectuate the data synchronization with the server 602. Another assessment, based on historical data of the mobile station, of an estimated number of messages to be blocked resulting from the data synchronization request is made 604 in order to obtain an estimated number of messages to be blocked. The total number of messages needed is compared 606 to determine whether it corresponds to the estimated number of messages to be blocked, specifically whether it is greater than according to this embodiment shown. If so, the output is set 608 as no delay (e.g., synchronize with the server), otherwise, the output is set 610 to delay the synchronization, and the process ends 612 at this point.

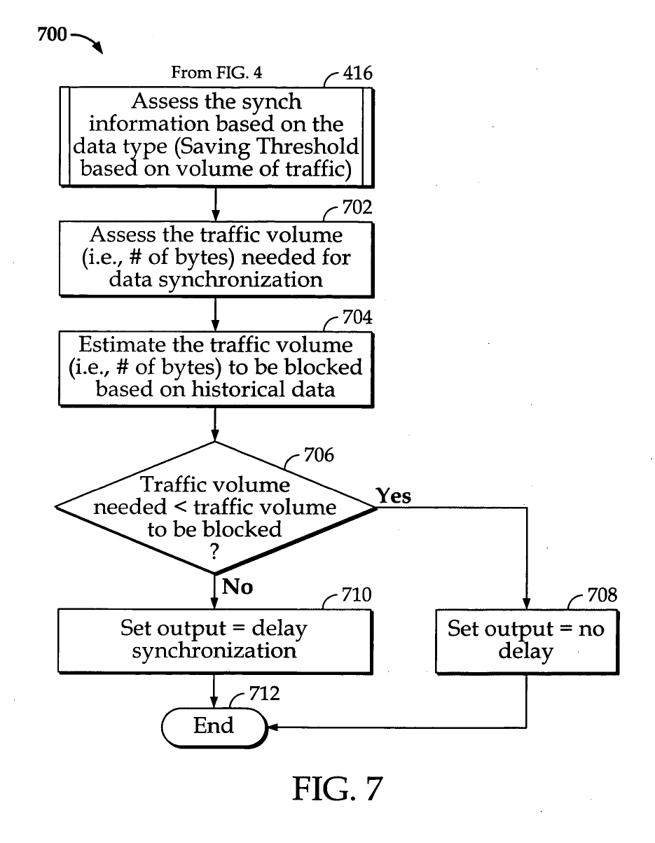

Turning now to FIG. 7, a flow chart diagram of an assessment process from FIG. 4 according to another embodiment is shown and indicated generally at 700. According to this embodiment, the assessment process 700 is implemented as a saving threshold based on volume of traffic related to the data synchronization request. The process 700 specifically starts with an assessment of a traffic volume (i.e., number of bytes) needed to synchronize the data related to the data synchronization request (i.e., to effectuate the data synchronization request with the server) 702, followed by an estimation of the traffic volume to be blocked based on historical data 704. The traffic volume needed for the data synchronization is compared to determine 706 whether it corresponds, specifically less than in this embodiment shown, to the traffic volume to be blocked. The output is set 708 without a delay when the traffic volume needed corresponds in the predetermined way with the traffic volume to be blocked, or otherwise, the output is set 710 to delay the synchronization, which ends 712 the process at this point.

With these various teachings shown, a novel data synchronization technique has been provided. One of the numerous benefits provided is that the balance between the benefits of data synchronization with the server and the cost of such synchronization is optimized by the various embodiments shown. For example, rather than immediately sending the configuration data to the server, the data can be temporarily stored in the mobile station to achieve the expected user experience. Moreover, because numerous characteristics (e.g., lifetime of the data based on policies and user behavior, magnitude of data, frequency of change, impact of storage location on the air interface resource usage) are considered in the optimization, a more robust and efficient data synchronization technique between the mobile station and the server is provided. With the various embodiments described, historical information on the user behavior are maintained and can further provide additional considerations for optimizing the frequency in which data is being synchronized with the network. Moreover, with the use of such historical information, a more intelligent process can be developed to assess an optimized synchronization timing that is based on the historical information and real time changes of the system. Thus, a more dynamic, efficient, and robust wireless data synchronization technique has been provided with the various teachings provided.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
intercepting a data synchronization request to wirelessly synchronize data related to the data synchronization request with a server;
assessing synchronization information related to the data synchronization request;
determining whether the synchronization information corresponds in at least a predetermined way to a predefined condition;
synchronizing the data related to the data synchronization request with the server when the synchronization information corresponds in at least the predetermined way to the predefined condition.

2. The method according to claim 1 further comprising:
at least delaying synchronization of the data related to the data synchronization request with the server when the synchronization information does not correspond in at least the predetermined way to the predefined condition.

3. The method according to claim 1 further comprising, prior to assessing synchronization information related to the data synchronization request:
assessing a data type of the data related to the data synchronization request to provide an assessed data type;
wherein the predefined condition is based on the assessed data type.

4. The method according to claim 3 further comprising:
determining whether a total number of the data synchronization requests of a same data type corresponds in at least a predetermined way to a seldom threshold;
synchronizing the data related to the data synchronization request with the server when the total number of the data synchronization request of the same data type corresponds in at least the predetermined way to the seldom threshold.

5. The method according to claim 3 further comprising:
determining whether immediate data synchronization is required based on the assessed data type.

6. The method according to claim 1, wherein the synchronization information comprises any one or more selected from a group of a type of data to be synchronized, a total number of bytes needed to effectuate synchronizing the data related to the data synchronization request with the server, a total number of messages needed to effectuate synchronizing the data related to the data synchronization request with the server, historical information, learned user behavior, synchronization delay savings, profile information, signal condition, and pending synchronization operation.

7. The method according to claim 1, wherein the predefined condition comprises any one or more selected from a group of at least one threshold, historical data, profile information, time duration, maximum number of requests per time duration, prospective savings, signal condition, a total number of data synchronization requests intercepted for a predefined time, pending synchronization operation, and synchronization forced by the user.

8. The method according to claim 1, wherein the data synchronization request comprises any one or more selected from a group of a push to talk session barring flag, a push to talk burst barring flag, changed data in contact lists, changed data in access lists, presence data, and service policy data.

9. The method according to claim 1, wherein determining whether the synchronization information corresponds in at least a predetermined way to the predefined condition further comprises:
assess a total number of messages needed to synchronize the data related to the data synchronization request to provide a total number messages needed;
estimate a total number of messages to be blocked from the data synchronization request based on historical data to provide a total number of messages to be blocked;
determining whether the total number of messages to be blocked corresponds in at least a predetermined way to the total number of messages needed;
at least delaying synchronization of the data related to the data synchronization request with the server when the total number of messages to be blocked does not correspond in at least the predetermined way to the total number of messages needed.

10. The method according to claim 1, wherein determining whether the synchronization information corresponds in at least a predetermined way to the predefined condition further comprises:
assess a total number of bytes needed to synchronize the data related to the data synchronization request to provide a total number bytes needed;
estimate a total number of bytes to be blocked from the data synchronization request based on historical data to provide a total number of bytes to be blocked;
determining whether the total number of bytes to be blocked corresponds in at least a predetermined way to the total number of bytes needed;
at least delaying synchronization of the data related to the data synchronization request with the server when the total number of bytes to be blocked does not correspond in at least the predetermined way to the total number of bytes needed.

11. The method according to claim 1, wherein determining whether the synchronization information corresponds in at least a predetermined way, to the predefined condition further comprises:
determining whether a delay timer corresponds in at least a predetermined way to a timer threshold;
at least delaying synchronization of the data related to the data synchronization request with the server when the delay timer does not correspond in at least the predetermined way to the timer threshold.

12. The method according to claim 1, wherein determining whether the synchronization information corresponds in at least a predetermined way to the predefined condition further comprises:
assess memory required to synchronize the data related to the data synchronization request to provide assessed memory required;
determining whether the assessed memory required corresponds in at least a predetermined way to a memory threshold;
at least delaying synchronization of the data related to the data synchronization request with the server when the assessed memory required does not correspond in at least the predetermined way to the memory threshold.

13. The method according to claim 1, wherein synchronizing the data related to the data synchronization request with the server further comprises:
determining whether other related data are required for synchronization;
preparing the data related to the data synchronization request to include other related data when other related data are required for synchronization.

14. An apparatus comprising:
an interception circuit that intercepts a data synchronization request to wirelessly synchronize data related to the data synchronization request with a server;
an assessor circuit that assesses synchronization information related to the data synchronization request and compares the synchronization information with a predefined condition to provide a comparison, wherein the data synchronization request is synchronized with the server based on the comparison.

15. The apparatus according to claim 14, wherein the assessor circuit further determines whether the synchronization information corresponds in at least a predetermined way to the predefined condition and instructs synchronization of the data related to the data synchronization request with the server when the synchronization information corresponds in at least the predetermined way to the predefined condition.

16. The apparatus according to claim 15 further comprising:
a synchronization circuit that synchronizes the data related to the data synchronization request with the server responsive to instruction from the assessor circuit or a user request.

17. The apparatus according to claim 15, wherein the assessor circuit at least delays the synchronization of the data related to the data synchronization request with the server when the synchronization information does not correspond in at least the predetermined way to the predefined condition.

18. A computer-readable medium having computer-executable instructions for performing the steps for:
intercepting a data synchronization request to wirelessly synchronize data related to the data synchronization request with a server;
assessing synchronization information related to the data synchronization request;
determining whether the synchronization information corresponds in at least a predetermined way to a predefined condition;
synchronizing the data related to the data synchronization request with the server when the synchronization information corresponds in at least the predetermined way to the predefined condition.
